(19) United States
(12) Patent Application Publication
(10) Pub. No.: US 2013/0181558 A1
(43) Pub. Date: Jul. 18, 2013

(54) ROTATING DEVICE

(71) Applicant: ALPHANA TECHNOLOGY CO., LTD., Shizuoka (JP)

(72) Inventors: Mitsuo KODAMA, Shizuoka (JP); Keisuke SUZUKI, Shizuoka (JP); Takuji YAMADA, Shizuoka (JP); Shigeyoshi MORI, Shizuoka (JP)

(73) Assignee: ALPHANA TECHNOLOGY CO., LTD., Shizuoka (JP)

(21) Appl. No.: 13/736,717

(22) Filed: Jan. 8, 2013

(30) Foreign Application Priority Data
Jan. 16, 2012 (JP) 2012-006024

(51) Int. Cl. H02K 7/08

(52) U.S. Cl. CPC H02K 7/086
USPC 310/90

(57) ABSTRACT

A rotating device comprises a stator configured to rotatably support a rotor via a lubricant. A first zonal region is formed on an inner surface of a sleeve. A plurality of grooves along a direction that crosses the first zonal region are formed on the first zonal region from each of both sides of the first zonal region. A groove formed from one side of the first zonal region is formed so that the closer a position in the groove is to the other side of the first zonal region, the shallower and the narrower the groove at the position will be. A groove formed from the other side is formed so that the closer a position in the groove is to the one side, the shallower and the narrower the groove at the position will be.

### CROSS-REFERENCE TO RELATED APPLICATIONS

This application is based upon and claims the benefit of priority from the prior Japanese Patent Application No. 2012-006024, filed on Jan. 16, 2012, the entire content of which is incorporated herein by reference.

### BACKGROUND OF THE INVENTION

1. Field of the Invention

The present invention relates to a rotating device comprising a stator configured to rotatably support a rotor via a lubricant.

2. Description of the Related Art

Disk drive devices, such as hard disk drives, have become miniaturized. The capacity of a disk drive device has also been increased. Such disk drive devices have been installed in various types of electronic devices. In particular, such disk drive devices have been installed in portable electronic devices such as laptop computers or portable music players.

A fluid dynamic bearing is a known bearing for the disk drive device. In a fluid dynamic bearing, a lubricant is injected into a gap between a rotor and a stator, and the fluid dynamic bearing maintains a state in which the rotor does not touch the stator by dynamic pressure created in the lubricant when the rotor rotates with respect to the stator (for example, reference should be made to Japanese Patent Application Publication No. 2010-131732 and Japanese Patent Application Publication No. 2011-58595).

### SUMMARY OF THE INVENTION

Since a misalignment of the head with respect to the disk may cause read/write errors, it is important to improve impact resistance in the field of disk drive devices. In particular, with regard to disk drive devices that are installed in portable electronic devices, it is necessary to have improved impact resistance so that the disk drive devices can withstand sorts of impacts, such as those due to dropping, which is not often encountered in the case of stationary electronic devices such as personal computers.

One of the methods for improving the impact resistance of the disk drive device that adopts a fluid dynamic bearing is to strengthen the radial stiffness by increasing the radial dynamic pressure. However, in general, increasing the radial dynamic pressure requires more power consumption. In particular, since many portable electronic devices use batteries for actuation, installation of such a disk drive device with high power consumption may shorten the available battery life.

This disadvantage, i.e., the conflict between the improvement of the impact resistance and the reduction of the power consumption, may occur not only in a disk drive device installed in a portable electronic device but also in other types of rotating devices.

The present invention addresses at least the above disadvantage, and a general purpose of one embodiment of the present invention is to provide a rotating device that can improve impact resistance while suppressing an increase in the power consumption according to the improvement of the impact resistance.

An embodiment of the present invention relates to a rotating device. The rotating device comprises a stator configured to rotatably support a rotor via a lubricant. A zonal region configured to surround a rotational axis of the rotor is formed on either one of a surface of the rotor and a surface of the stator, the surface of the rotor and the surface of the stator together forming a gap into which the lubricant is filled, and the zonal region creating dynamic pressure in the lubricant when the rotor rotates. A plurality of grooves along a direction that crosses the zonal region are formed on the zonal region from each of the both sides of the zonal region. A groove formed from one side of the zonal region is formed so that the closer a position in the groove is to the other side of the zonal region, the shallower and the narrower the groove at the position will be. A groove formed from the other side of the zonal region is formed so that the closer a position in the groove is to the one side of the zonal region, the shallower and the narrower the groove at the position will be.

A further embodiment of the present invention relates to a rotating device. The rotating device comprises a stator configured to rotatably support a rotor via a lubricant. A zonal region configured to surround a rotational axis of the rotor is formed on either one of a surface of the rotor and a surface of the stator, the surface of the rotor and the surface of the stator together forming a gap into which the lubricant is filled, and the zonal region creating dynamic pressure in the lubricant when the rotor rotates. A plurality of grooves along a direction that crosses the zonal region are formed on the zonal region from one side of the zonal region towards the other side of the zonal region. A groove formed from one side of the zonal region is formed so that the closer a position in the groove is to the other side of the zonal region, the shallower and the narrower the groove at the position will be.

A further embodiment of the present invention relates to a rotating device. The rotating device comprises a stator configured to rotatably support a rotor via a lubricant. A zonal region configured to surround a rotational axis of the rotor is formed on either one of a surface of the rotor and a surface of the stator, the surface of the rotor and the surface of the stator together forming a gap into which the lubricant is filled, and the zonal region creating dynamic pressure in the lubricant when the rotor rotates. A plurality of grooves along a direction that crosses the zonal region are formed on the zonal region from each of both sides of the zonal region. A groove formed from one side of the zonal region is formed so that the closer a position in the groove is to the other side of the zonal region, the less the cross sectional area of the groove at the position will be, the cross section being taken in a direction along which the zonal region extends. A groove formed from the other side of the zonal region is formed so that the closer a position in the groove is to the one side of the zonal region, the less the cross sectional area of the groove at the position will be, the cross section being taken in a direction along which the zonal region extends.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1A and FIG. 1B are a top view and a side view, respectively, of a rotating device according to an embodiment;

FIG. 2 is a section view sectioned along line A-A in FIG. 1A;

FIG. 3 is a development of a first radial dynamic pressure groove forming region of FIG. 2;

FIG. 4 is a section view sectioned along line B-B in FIG. 3;

FIGS. 5A, 5B, 5C, and 5D are section views in which radial dynamic pressure grooves are sectioned in a direction in which a radial dynamic pressure groove forming region extends;

FIG. 6 is a contour view showing the representative results of simulations;

FIG. 7 is a contour view showing the representative results of simulations; and

FIG. 8 is a development of a first radial dynamic pressure groove forming region according to a modification.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

A rotating device according to an embodiment adopts a fluid dynamic bearing. The rotating device comprises a rotor and a stator rotatably supporting the rotor via a lubricant. A dynamic pressure groove, which creates a dynamic pressure in the lubricant in the rotating mode of the rotating device, is formed on a region so that the dynamic pressure groove tapers from the region's side to center. This may allow more efficient creation of dynamic pressure.

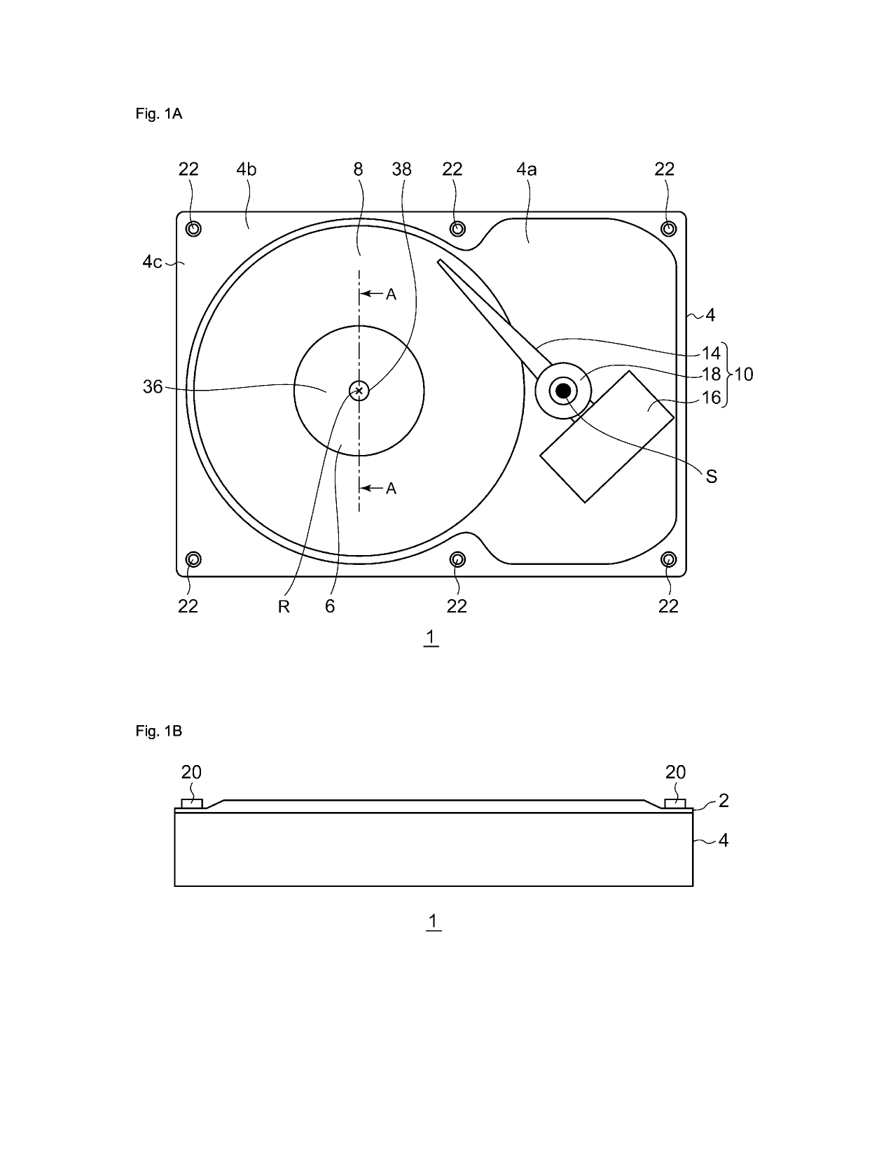

FIG. 1A and FIG. 1B are a top view and a side view, respectively, of the rotating device 1 according to this embodiment. FIG. 1A is the top view of the rotating device 1. In FIG. 1A, the rotating device 1 is shown without a top cover 2 in order to show the inside of the rotating device 1. The rotating device 1 comprises: a base 4; a rotor 6; a magnetic recording disk 8; a data read/write unit 10; and the top cover 2. Hereinafter, it is assumed that the side of the base 4 on which the rotor 6 is installed is the “upper” side.

The magnetic recording disk 8 is a 3.5-inch type glass magnetic recording disk, the diameter of which being 95 mm. The diameter of the central hole of the magnetic recording disk 8 is 25 mm, and the thickness of the disk 8 is 1.27 mm. The rotating device 1 has two such magnetic recording disks 8. Each magnetic recording disk 8 is mounted on the rotor 6 and rotates with the rotor 6. The rotor 6 is rotatably mounted to the base 4 through the bearing unit 12, which is not shown in FIG. 1A.

The base 4 includes: a bottom plate 4a forming the bottom portion of the rotating device 1; and an outer circumference wall 4b formed along the outer circumference of the bottom plate 4a so that the outer circumference wall 4b surrounds an installation region of the magnetic recording disk 8. Six screw holes 22 are formed on the upper surface 4c of the outer circumference wall 4b.

The data read/write unit 10 includes: a read/write head (not shown); a swing arm 14; a voice coil motor 16; and a pivot assembly 18. The read/write head is attached to the tip of the swing arm 14. The read/write head records data onto and reads out data from the magnetic recording disk 8. The pivot assembly 18 swingably supports the swing arm 14 with respect to the base 4 around the head rotation axis S. The voice coil motor 16 swings the swing arm 14 around the head rotation axis S and moves the read/write head to the desired position on the upper surface of the magnetic recording disk 8. The voice coil motor 16 and the pivot assembly 18 are constructed using a known technique for controlling the position of the head.

FIG. 1B is the side view of the rotating device 1. The top cover 2 is fixed onto the upper surface 4c of the base 4's outer circumference wall 4b by using six screws 20. The six screws 20 correspond to the six screw holes 22, respectively. In particular, the top cover 2 and the upper surface 4c of the outer circumference wall 4b are fixed together so that a joint portion where both meet does not create a leak into the inside of the rotating device 1.

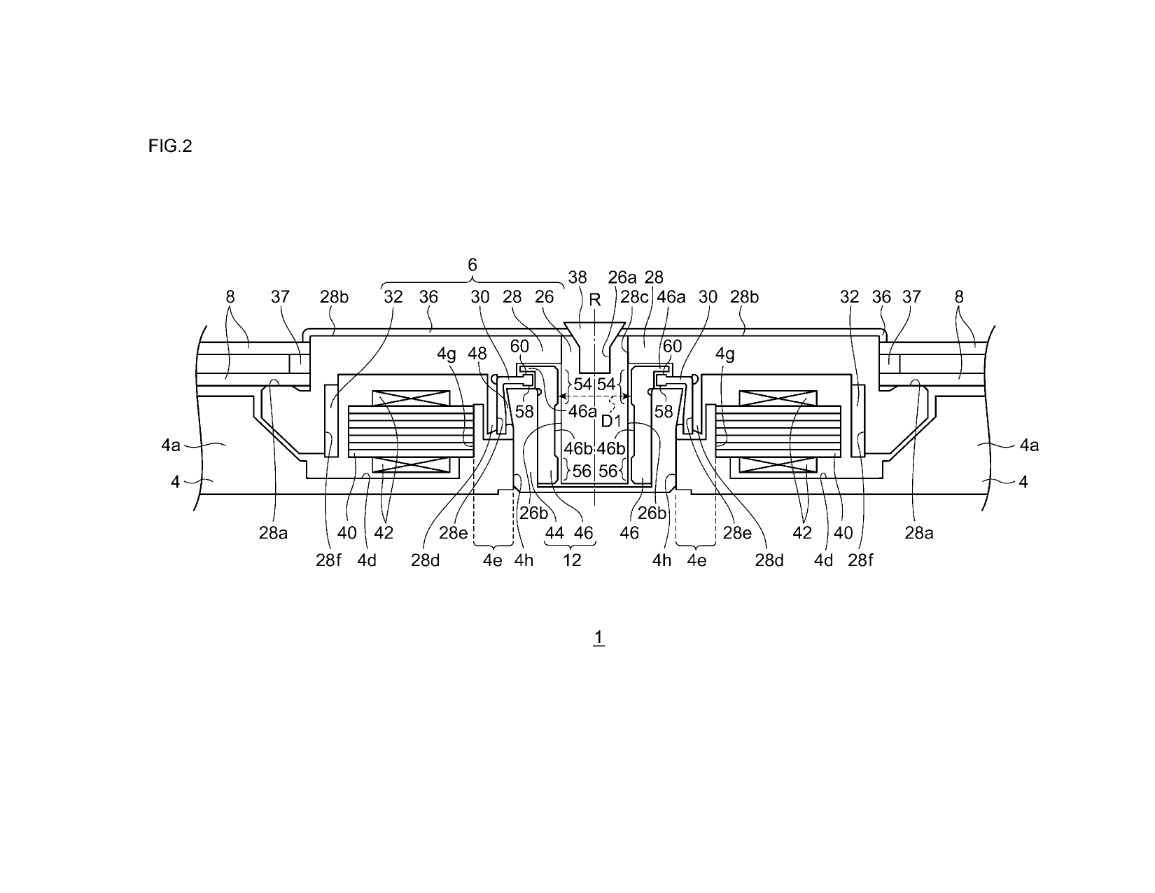

FIG. 2 is a view that is sectioned along the line A-A, as illustrated in FIG. 1A. The rotor 6 includes a shaft 26, a hub 28, a flange 30, a cylindrical magnet 32, and a clamper 36. The magnetic recording disk 8 is mounted on a disk-mount surface 28a of the hub 28. A screw hole 26a for affixing the disk is provided on an upper end surface of the shaft 26. The clamper 36 is pressed against the upper surface 28b of the hub 28 by a screw 38, which is screwed in the screw hole 26a for affixing the disk. The clamper 36 presses the upper one of the two magnetic recording disks 8 against a spacer 37. The spacer 37 presses the lower one of the two magnetic recording disks 8 against a disk-mount surface 28a of the hub 28.

The hub 28 is made of soft-magnetic steel such as SUS430F. The hub 28 is formed to be predetermined cup-like shape by, for example, the press working or cutting of a steel plate. For example, the hub 28 may preferably be made of the stainless steel (DHS1) provided by Daido Steel Co., Ltd. since the stainless steel has lower outgas and is easily-worked. The hub 28 may more preferably be made of the stainless steel (DHS2) provided by Daido Steel Co., Ltd. since the stainless steel has high corrosion resistance.

The shaft 26 is fixed in the hole 28c arranged at the center of the hub 28 by using both press-fitting and glue, the hole 28c being arranged coaxially with the rotational axis R of the rotor 6. The flange 30 is in a ring-shape and has a reverse L-shaped cross section. The flange 30 is glued on an inner surface 28e of a hanging portion 28d of the hub 28.

The cylindrical magnet 32 is glued onto a cylindrical inner surface 28f, which is an inner cylindrical surface of the hub 28. The cylindrical magnet 32 is made of a rare-earth material such as Neodymium, Iron, or Boron. The cylindrical magnet 32 faces radially towards twelve teeth of the laminated core 40. The cylindrical magnet is magnetized for driving, with sixteen poles along the circumferential direction (i.e., in a tangential direction of a circle, the center of which being in the rotational axis R and the circle being perpendicular to the rotational axis R). The surface of the cylindrical magnet 32 is treated with electro deposition coating or spray coating to prevent rusting.

The base 4, a laminated core 40, coils 42, a housing 44 and a sleeve 46 form the stator of the rotating device 1. The laminated core 40 has a ring portion and twelve teeth, which extend radially (i.e., in a direction perpendicular to the rotational axis R) outwardly from the ring portion, and is fixed on the upper surface 4d side of the base 4. The laminated core 40 is formed by laminating seven thin magnetic steel sheets and mechanically integrating them. An insulation coating is applied onto the surface of the laminated core 40 by electrodeposition coating or powder coating. Each of the coils 42 is wound around one of the twelve teeth, respectively. A driving flux is generated along the teeth by applying a three-phase sinusoidal driving current through the coils 42. A ring-shaped wall 4e, the center of which being along the rotational axis R of the rotor 6, is formed on the upper surface 4d of the base 4. The laminated core 40 is fitted to the outer surface 4g of the ring-shaped wall 4e with a press-fit or clearance fit and glued thereon.

A through hole 4h, the center of which being along the rotational axis R of the rotor 6, is formed on the base 4. The bearing unit 12 includes the housing 44 and the sleeve 46 and rotatably supports the rotor 6 with respect to the base 4. The housing 44 is glued into the through hole 4h of the base 4. The housing 44 is formed to be cup-shaped by integrating a cylindrical portion and a bottom portion as a single unit. The housing 44 is glued to the base 4 with the bottom portion downside.

The cylindrical sleeve 46 is glued onto the inner side surface of the housing 44. A jetty portion 46a, which juts radially outward, is formed at the upper end of the sleeve 46. This jetty portion 46a, in cooperation with the flange 30, limits the motion of the rotor 6 in the axial direction (i.e., the direction parallel to the rotational axis R). The sleeve 46 accommodates the shaft 26. A lubricant 48 is injected into a gap between a part of the rotor 6 and the bearing unit 12, the part including the shaft 26, the hub 28, and the flange 30.

A first radial dynamic pressure groove forming region 54 and a second radial dynamic pressure groove forming region 56, which are separated from each other vertically, are formed on the inner surface 46b of the sleeve 46. Radial dynamic pressure grooves are formed on each of the first radial dynamic pressure groove forming region 54 and the second radial dynamic pressure groove forming region 56. The first radial dynamic pressure groove forming region 54 is a zonal region surrounding the rotational axis R and is formed so that the region is substantially parallel to the rotational axis R. In that, the first radial dynamic pressure groove forming region 54 is a cylindrical region, the center of which being along the rotational axis R. Therefore, the direction in which the first radial dynamic pressure groove forming region 54 extends is the circumferential direction. The second radial dynamic pressure groove forming region 56 is arranged in a similar manner. When the rotor 6 rotates, the rotor 6 is radially supported, without touching the stator, by the dynamic pressure generated in the lubricant 48 by the radial dynamic pressure grooves formed on the first radial dynamic pressure groove forming region 54 and the second radial dynamic pressure groove forming region 56.

A first thrust dynamic pressure groove forming region 58 is formed on the lower surface of the flange 30 that faces the upper surface of the housing 44. A second thrust dynamic pressure groove forming region 60 is formed on the upper surface of the flange 30 that faces the lower surface of the jetty portion 46a. Thrust dynamic pressure grooves are formed on each of the first thrust dynamic pressure groove forming region 58 and the second thrust dynamic pressure groove forming region 60. The first thrust dynamic pressure groove forming region 58 is a zonal region surrounding the rotational axis R and is formed so that the region is substantially perpendicular to the axial direction. In that, the first thrust dynamic pressure groove forming region 58 is a disk-like region, the center of which being along the rotational axis R. Therefore, the direction in which the first thrust dynamic pressure groove forming region 58 extends is the circumferential direction. The second thrust dynamic pressure groove forming region 60 is arranged in a similar manner. When the rotor 6 rotates, the rotor 6 is axially supported, without touching the stator, by the dynamic pressure generated in the lubricant 48 by the thrust dynamic pressure grooves formed on the first thrust dynamic pressure groove forming region 58 and the second thrust dynamic pressure groove forming region 60.

In other embodiments, at least one of the first radial dynamic pressure groove forming region 54 and the second radial dynamic pressure groove forming region 56 may be formed on the outer surface 26b of the shaft 26 instead of the inner surface 46b of the sleeve 46. In other embodiments, the first thrust dynamic pressure groove forming region 58 may be formed on the upper surface of the housing 44, and the second thrust dynamic pressure groove forming region 60 may be formed on the lower surface of the jetty portion 46a.

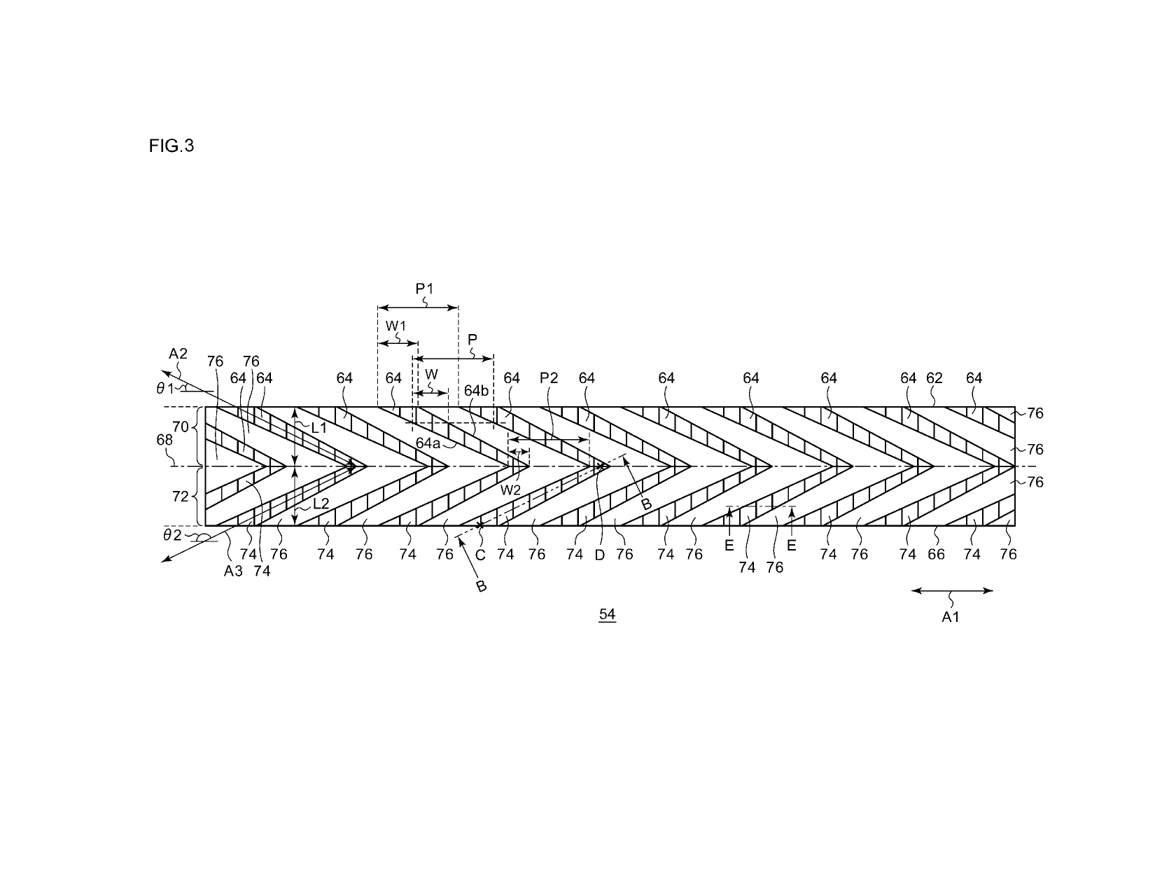

FIG. 3 is a development of a first radial dynamic pressure groove forming region 54. The radial dynamic pressure grooves formed on the first radial dynamic pressure groove forming region 54 are regularly arranged in the circumferential direction A1. In addition, the grooves are arranged so that the grooves are substantially symmetric with respect to a central line 68, which substantially bisects the first radial dynamic pressure groove forming region 54. The central line 68 divides the region 54 into an upper part and a lower part. In particular, radial dynamic pressure grooves of substantially the same shape are arranged on the first radial dynamic pressure groove forming region 54 at substantially regular intervals. The first radial dynamic pressure groove forming region 54 has an axisymmetric arrangement in which the symmetric axis is the central line 68. The first radial dynamic pressure groove forming region 54 is divided into an upper forming region 70 and a lower forming region 72 with their boundary at the central line 68. The width L1 of the upper forming region 70 is substantially equal to the width L2 of the lower forming region 72.

Ten upper radial dynamic pressure grooves 64 are formed on the upper forming region 70 from the upper edge 62 of the first radial dynamic pressure groove forming region 54 towards the central line 68. Each upper radial dynamic pressure groove 64 is formed along a direction that crosses the upper forming region 70. The direction is an upper crossing direction A2 that crosses the circumferential direction A1, the angle formed by the upper crossing direction A2 and the circumferential direction A1 being a first groove angle θ1. Each upper radial dynamic pressure groove 64 is formed so that the closer a position in the groove 64 is to the lower edge 66, the shallower and the narrower the groove 64 at the position will be. In other words, each upper radial dynamic pressure groove 64 is formed so that the closer a position in the groove 64 is to the lower edge 66, the less the cross sectional area of the groove 64 at the position will be, the cross section being taken in the direction A1 along which the radial dynamic pressure groove forming region extends.

The pitch P of the groove is the distance, in the circumferential direction A1, between two upper radial dynamic pressure grooves 64, which are adjacent in the circumferential direction Al. The width W of the groove is the distance, in the circumferential direction A1, between edges 64a, 64b of one upper radial dynamic pressure groove 64. Each upper radial dynamic pressure groove 64 is formed so that the closer a position in the groove 64 is to the lower edge 66, the less the ratio of the width W of the groove 64 at the position to the pitch P of the groove 64 at the position will be. The ratio is W/P and hereinafter is referred to as groove ratio. The pitch and the width of the groove at the upper edge 62 are denoted as P1 and W1, respectively. The pitch and the width of the groove at the central line 68 are denoted as P2 and W2, respectively. In this embodiment, the above change of the groove ratio is realized by changing the width W of the groove without changing the pitch P of the groove. In that, P1=P2, and W1>W2.

Ten lower radial dynamic pressure grooves 74 are formed on the lower forming region 72 from the lower edge 66 of the first radial dynamic pressure groove forming region 54 towards the central line 68. Each lower radial dynamic pressure groove 74 is formed along a direction that crosses the lower forming region 72. The direction is an lower crossing direction A3 that crosses the circumferential direction A1, the angle formed by the lower crossing direction A3 and the circumferential direction Al being a second groove angle θ2. The sum of the first groove angle θ1 and the second groove angle θ2 is substantially equal to 180 degrees. Each lower radial dynamic pressure groove 74 is formed so that the closer a position in the groove 74 is to the upper edge 62, the shallower and the narrower the groove 74 at the position will be. In other words, each lower radial dynamic pressure groove 74 is formed so that the closer a position in the groove 74 is to the upper edge 62, the less the cross sectional area of the groove 74 at the position will be, the cross section being taken in the direction A1 along which the radial dynamic pressure groove forming region extends.

The pitch and the width of the groove of the lower radial dynamic pressure grooves 74 are arranged in the way similar to that of the upper radial dynamic pressure grooves 64. The end portion of the upper radial dynamic pressure groove 64 on the lower-edge 66 side is connected, at the central line 68, with the end portion of the corresponding lower radial dynamic pressure groove 74 on the upper-edge 62 side. Hereinafter, the upper radial dynamic pressure groove 64 and the corresponding lower radial dynamic pressure groove 74 connected with each other may be collectively referred to as a radial dynamic pressure groove.

FIG. 4 is a section view sectioned along line B-B in FIG. 3. “C” in FIG. 4 corresponds to point “C” in FIG. 3 and also corresponds to a position where the lower radial dynamic pressure groove 74 intersects with the lower edge 66. “D” in FIG. 4 corresponds to point “D” in FIG. 3 and also corresponds to a position where the lower radial dynamic pressure groove 74 intersects with the central line 68. The dashed line in FIG. 4 corresponds to a land portion 76 of the first radial dynamic pressure groove forming region 54. There is no radial dynamic pressure groove arranged on the land portion 76.

The depth DE of the groove is the distance, in the radial direction A4, from the land portion 76 to a bottom surface 74c of the lower radial dynamic pressure groove 74. Each lower radial dynamic pressure groove 74 is formed so that the closer a position in the groove 74 is to the upper edge 62, the less the depth DE of the groove 74 at the position will be. The depth of the groove at the lower edge 66 is denoted as DE1 and the depth of the groove at the central line 68 is denoted as DE2. The depth DE of each lower radial dynamic pressure groove 74 changes linearly from DE1 to DE2 as the position in the groove 74 gets close to the upper edge 62. The depth of the upper radial dynamic pressure groove 64 is arranged in a similar manner.

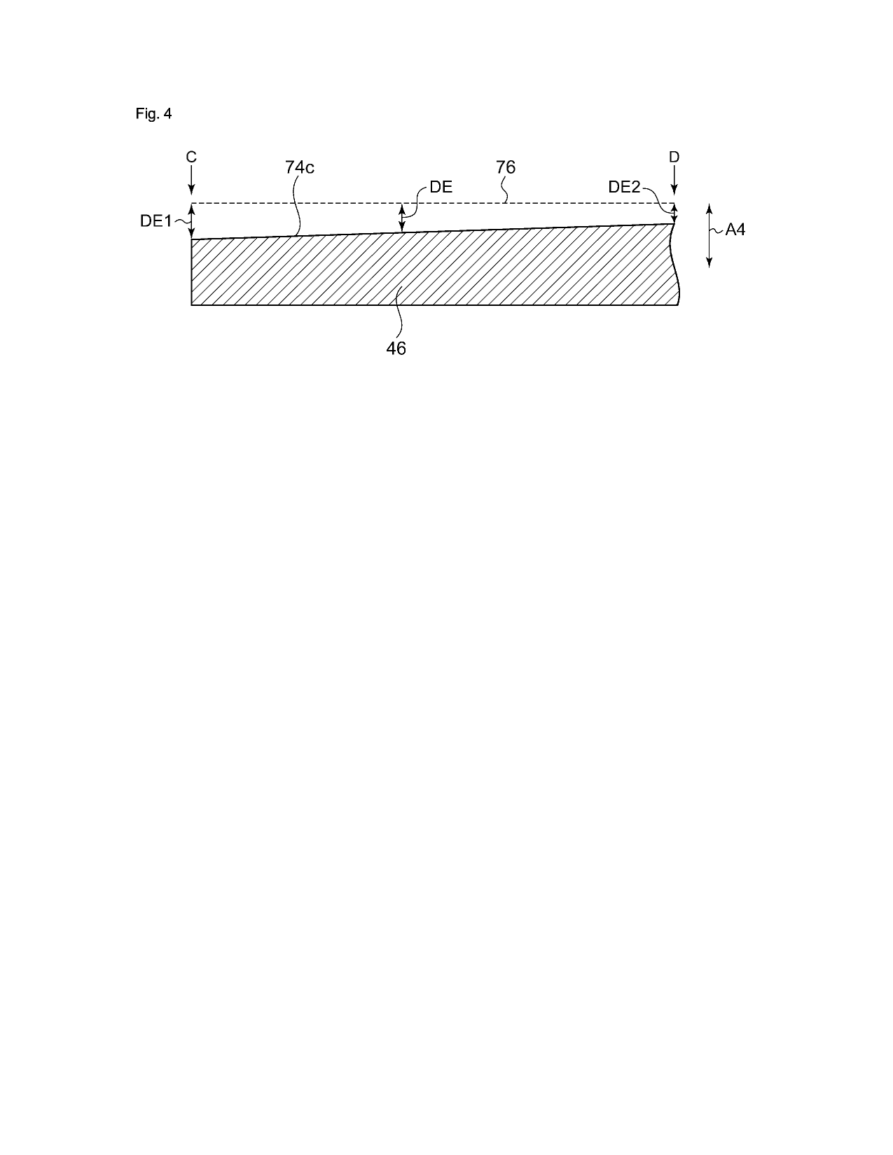

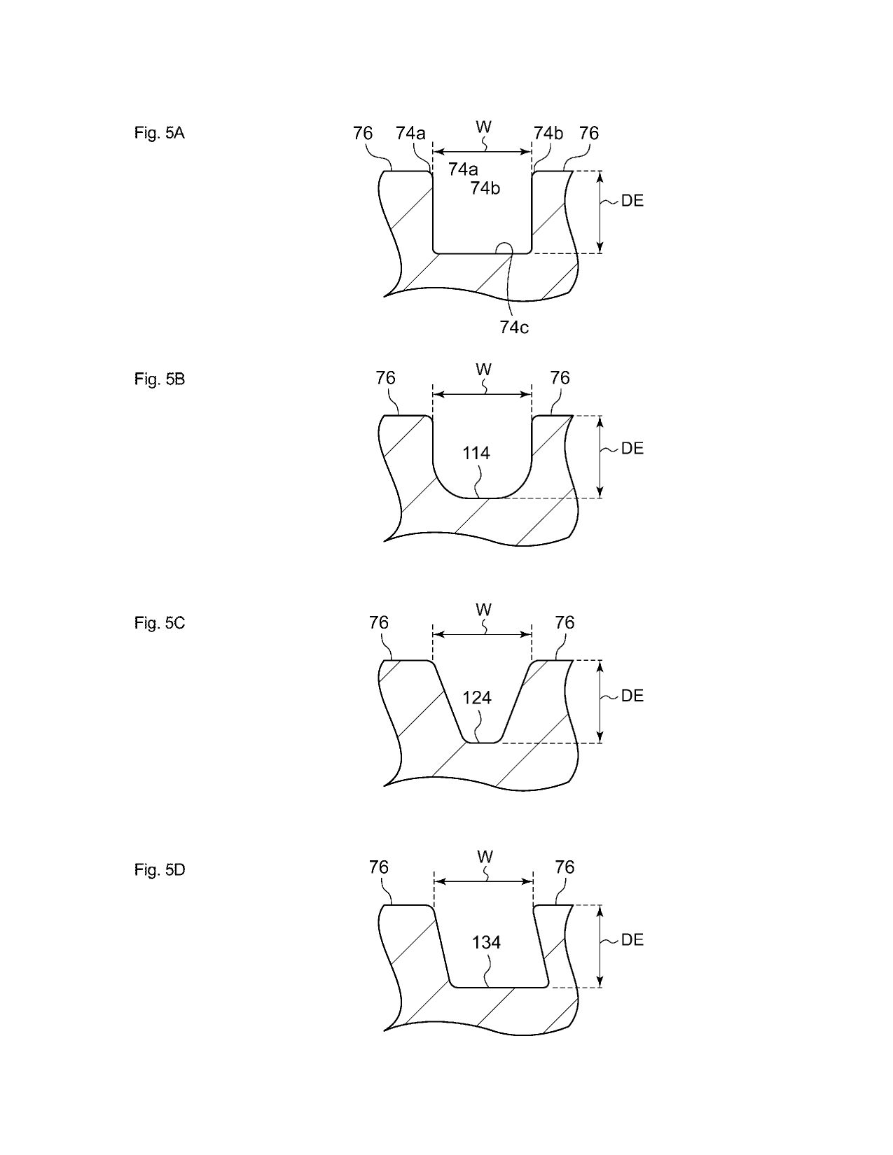

FIGS. 5A, 5B, 5C, and 5D are section views in which radial dynamic pressure grooves are sectioned in a direction in which the radial dynamic pressure groove forming region extends. FIG. 5A is a section view sectioned along line E-E in FIG. 3. The cross section of the lower radial dynamic pressure groove 74 is substantially rectangular. The edges 74a, 74b of the lower radial dynamic pressure groove 74 are formed at a right angle, substantially. The edges of the upper radial dynamic pressure groove 64 are formed in a similar manner.

It is noted that, in FIGS. 5A, 5B, 5C, and 5D, the rate of magnification in the depth direction is shown as greater than the rate of magnification in the width direction so as to ease the understanding of the shape of the groove.

FIGS. 5B, 5C, and 5D show modifications to the cross section of the lower radial dynamic pressure groove. Referring to FIG. 5B, the cross section of the lower radial dynamic pressure groove 114 is “U”-shaped or arc-shaped. Referring to FIG. 5C, the cross section of the lower radial dynamic pressure groove 124 is “V”-shaped or reverse-trapezoid-shaped. Referring to FIG. 5D, the cross section of the lower radial dynamic pressure groove 134 is parallelogram-shaped. As shown above, it is possible to have an asymmetric cross section. In any of the above cases, the depth DE of a groove is defined to be the distance between the land portion 76 and the bottom surface of the groove. On the other hand, the width W of the groove is defined as the distance, in the circumferential direction A1, between the edges of the groove as shown in FIGS. 5A, 5B, 5C, and 5D. In particular, the width W of the groove is defined as the distance, excluding process-originated “corner slope” portion around the boundary, to the land portion 76, substantially.

In particular, in the case where the radial dynamic pressure grooves are processed by cutting using an edged tool, piezoelectric process surfaces are formed on such radial dynamic pressure grooves, as represented by FIGS. 5A, 5B, and 5C. The edge of the edged tool is actuated in the radial direction using a piezoelectric element. Such a process is preferred as an piezoelectric process surface having an arc-like cross section, as represented by FIG. 5B, is easy to form.

With regard to the ratio of the width to the depth of the radial dynamic pressure groove, the upper radial dynamic pressure groove 64 is formed so that the depth DE2 of the other end of the groove 64 is less than two-thirds the depth DE1 of one end of the groove 64 and that the ratio of the width W2 to the depth DE2 of the groove 64 at the other end of the groove 64 is 0.67 to 1.50 times the ratio of the width W1 to the depth DE1 of the groove 64 at the one end of the groove 64, the one end of the groove 64 corresponding to the upper-edge 62 side and the other end of the groove 64 corresponding to the lower-edge 66 side. The upper radial dynamic pressure groove 64 is formed so that the ratio of the width to the depth of the groove 64 at any portion in the groove 64 is 0.67 to 1.50 times the ratio of the width W1 to the depth DE1 of the groove 64 at the one end of the groove 64. The ratio with regard to the lower radial dynamic pressure groove 74 is arranged in the same manner. In other embodiments, the ratio of the width to the depth of the groove may be made constant (i.e., shapes of cross sections are made as similar figures) so that the closer the position in the groove is to the central line 68, the shallower the groove at the position will be.

Each of the second radial dynamic pressure groove forming region 56, the first thrust dynamic pressure groove forming region 58, and the second thrust dynamic pressure groove forming region 60 is arranged in a way similar to that of the first radial dynamic pressure groove forming region 54. Alternatively, spiral-shaped thrust dynamic pressure grooves may be formed on the first thrust dynamic pressure groove forming region 58 and the second thrust dynamic pressure groove forming region 60. In the case where the dynamic pressure groove is spiral-shaped, the groove formed from one side (a first side) of the region is formed so that the closer a position in the groove is to the other side (a second side) of the region, the shallower and the narrower the groove at the position will be. In the case of the thrust dynamic pressure groove, since the region on which the thrust dynamic pressure groove is formed is disk-like, the groove ratio corresponds to the ratio of the length of the arc of the groove portion to the length of the arc of the pitch along the circumferential direction. In the case where the thrust dynamic pressure groove is spiral-shaped, the groove can be formed so that the groove gets shallower and narrower in the radial direction when going from outside to inside the thrust dynamic pressure groove forming region. Alternatively, the groove can be formed so that the groove gets shallower and narrower as in the radial direction when going from inside to outside of the thrust dynamic pressure groove forming region. These may allow more efficient creation of dynamic pressure.

The operation of the rotating device 1, as described above, shall be described below. The three-phase driving current is supplied to the coils 42 to rotate the magnetic recording disk 8. Drive flux is generated along the twelve teeth by making the driving current flow through the coils 42. This driving flux gives torque to the cylindrical magnet 32, and the rotor 6 and the magnetic recording disk 8, which is fitted to the rotor 6, rotate.

In the rotating device 1 according to the present embodiment, each of the upper radial dynamic pressure grooves 64 is formed so that the closer a position in the groove 64 is to the lower edge 66, the shallower and the narrower the groove 64 at the position will be, and each lower radial dynamic pressure groove 74 is formed so that the closer a position in the groove 74 is to the upper edge 62, the shallower and the narrower the groove 74 at the position will be. Therefore, the dynamic pressure created around the central line 68 when the rotor 6 rotates can be increased. As a result, a higher dynamic pressure can be achieved using less driving current.

This increase of the dynamic pressure can intuitively be understood from the fact that the upper radial dynamic pressure groove 64 sucks in the lubricant 48 from the upper-edge 62 side when the rotor 6 rotates and the fact that the sucked-in lubricant 48 is compressed as it proceeds towards the central line 68 (the same applies to the lubricant 48, which is sucked in by the lower radial dynamic pressure groove 74). The present inventors recognize that a higher dynamic pressure is created since the pressure created by the suction of the lubricant 48 is added to the pressure caused by the above compression effect.

In the rotating device 1 according to the present embodiment, each of the second radial dynamic pressure groove forming region 56, the first thrust dynamic pressure groove forming region 58, and the second thrust dynamic pressure groove forming region 60 is arranged in a way similar to that of the first radial dynamic pressure groove forming region 54. Therefore, a higher dynamic pressure can be achieved with less driving current in each of these regions.

As a result, for example, it is possible to strengthen the radial stiffness at the first radial dynamic pressure groove forming region 54 and the second radial dynamic pressure groove forming region 56 so that the impact resistance is increased, while the increase of the power consumption according to the improvement of the impact resistance is suppressed.

The present inventors performed simulations under the following conditions in order to ensure the effect of the increase of the dynamic pressure of the rotating device 1 according to the present embodiment.
first groove angle θ1 is the range of 10 degrees to 30 degrees.
The diameter D1 of the first radial dynamic pressure groove forming region 54 is in the range of 1.5 mm to 4.5 mm.
The number of the radial dynamic pressure grooves on the first radial dynamic pressure groove forming region 54 is in the range of 8 to 12.

In the simulations, the rotating device 1 satisfying the above conditions is rotated at 5000 rpm and the radial stiffness is calculated while variedly changing the groove ratio or the depth of the groove.

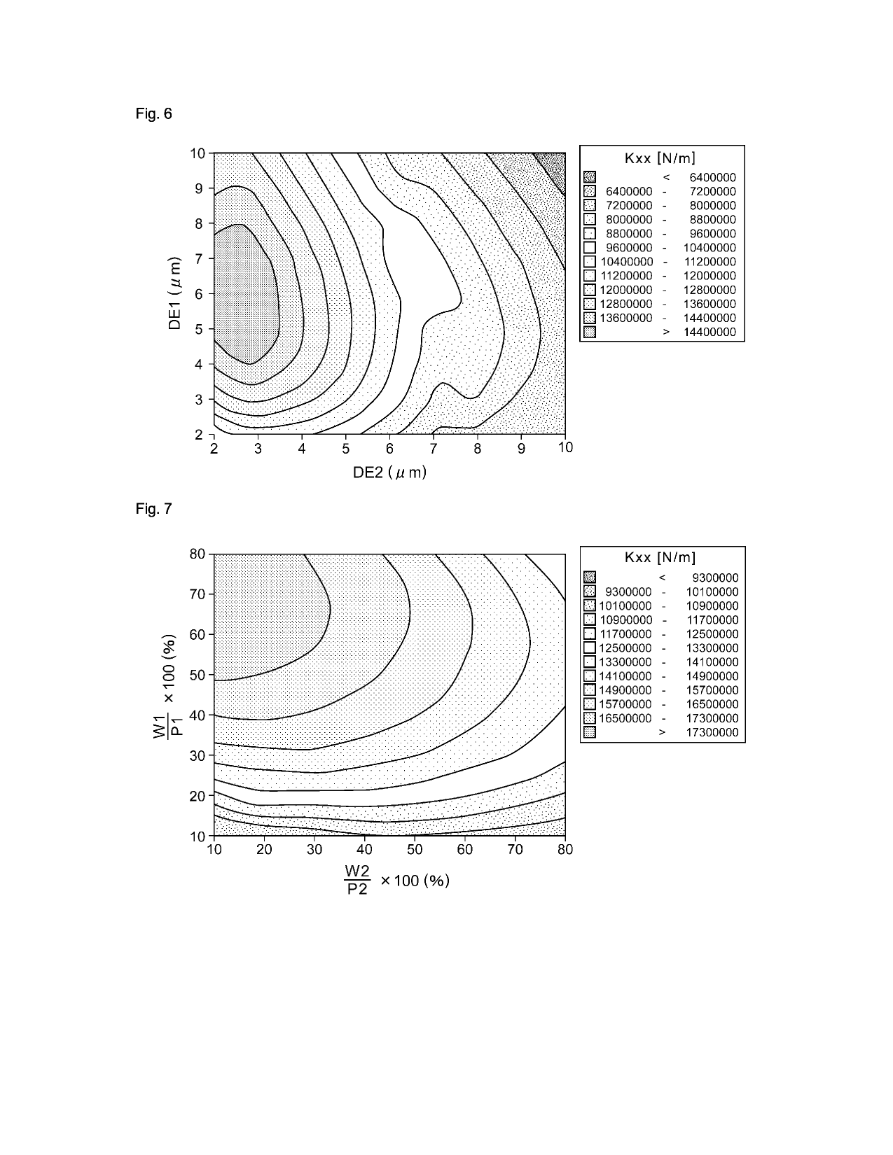

FIG. 6 is a contour view showing the representative results of simulations. Here, the diameter D1=4.0 mm, the first groove angle θ1=15 degrees, and the number of the radial dynamic pressure grooves=12. The groove ratio is set to be a constant value of 0.3 (i.e., W1/P1=W2/P2=0.3). Kxx (N/m) denotes the magnitude of the radial stiffness. Referring to FIG. 6, a larger radial stiffness can be obtained in the case where the radial dynamic pressure groove is formed so that DE1 is in the range of 4 μm to 8 μm and DE2 is in the range of 2 μm to 3.5 μm.

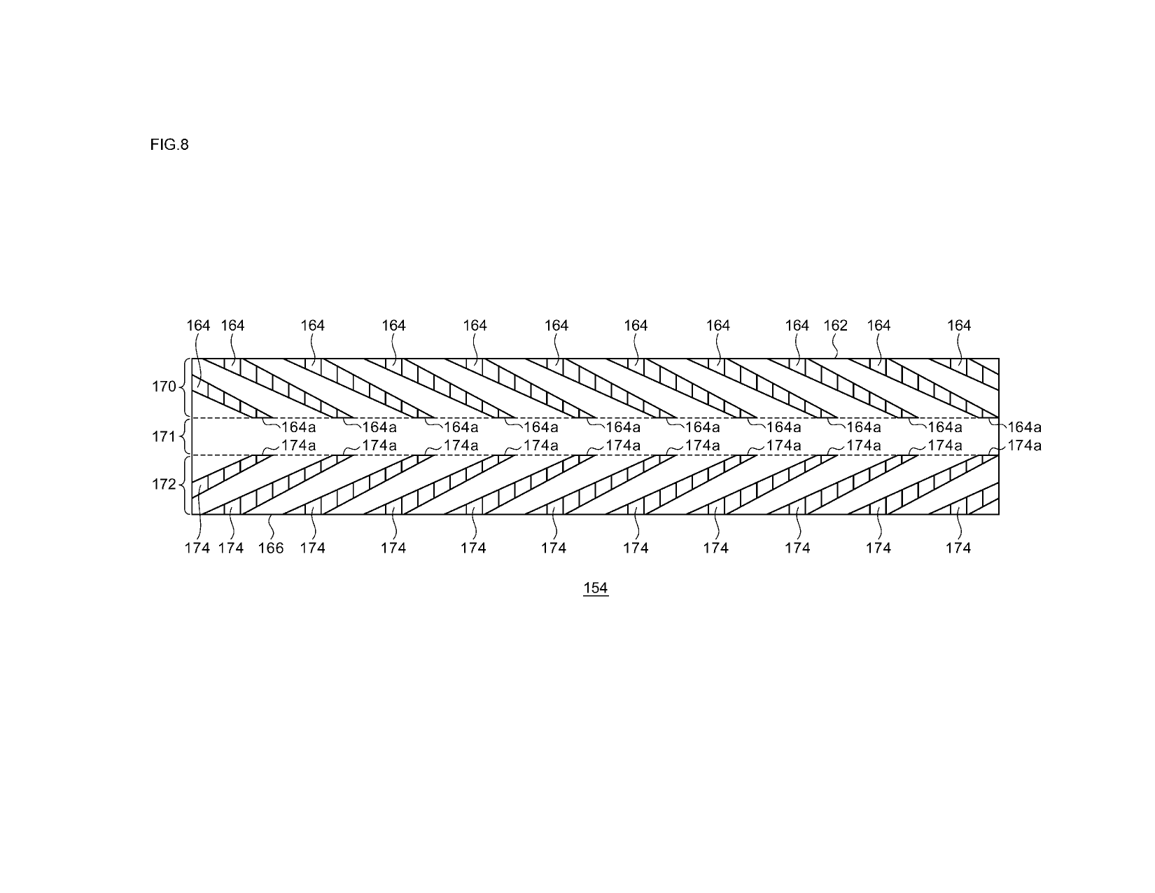

FIG. 7 is a contour view showing the representative results of simulations. Here, the diameter D1=4.0 mm, the first groove angle θ1=15 degrees, and the number of the radial dynamic pressure grooves=12. DE1 and DE2 are set to be 6.0 μm and 2.5 μm, respectively. Referring to FIG. 7, a larger radial stiffness can be obtained in the case where the radial dynamic pressure groove is formed so that W1/P1 is in the range of 0.50 (50 percent) to 0.80 (80 percent) and W2/P2 is in the range of 0.10 (10 percent) to 0.30 (30 percent).

Above is an explanation for the structure and operation of the rotating device according to the embodiment. This embodiment is intended to be illustrative only, and it will be obvious to those skilled in the art that various modifications to constituting elements and processes could be developed and that such modifications are also within the scope of the present invention.

The embodiment describes the so-called outer-rotor type of the rotating device in which the cylindrical magnet 32 is located outside the laminated core 40. However, the present invention is not limited to this. For example, the technical concept of the present embodiment can be applied to the so-called inner-rotor type of the rotating device in which a cylindrical magnet is located inside the laminated core.

The embodiment describes the case where the bearing unit 12 is fixed to the base 4 and where the shaft 26 rotates with respect to the bearing unit 12. However, the present invention is not limited to this. For example, the technical concept of the present embodiment can be applied to a fixed-shaft type of the rotating device in which the shaft is fixed to the base and in which the bearing unit and the hub rotate together with respect to the shaft.

The embodiment describes the case where the bearing unit 12 is directly mounted onto the base 4. However, the present invention is not limited to this. For example, a brushless motor comprising a rotor, a bearing unit, a laminated core, coils, and a base can separately be manufactured, and the manufactured brushless motor can be installed on a chassis.

The embodiment describes the case where the laminated core is used. However, the present invention is not limited to this. The core does not have to be a laminated core.

The embodiment describes the case where the groove ratio or the depth of the groove is changed in a linear manner. However, the present invention is not limited to this. For example, the groove ratio or the depth of the groove may be changed in a stepwise manner or in a rounded manner.

The embodiment describes the case where the radial dynamic pressure grooves of the first radial dynamic pressure groove forming region 54 are formed so that they are substantially symmetric with respect to the central line 68. However, the present invention is not limited to this. For example, the width L1 of the upper forming region may be different from the width L2 of the lower forming region. The radial dynamic pressure groove formed on each forming region may be formed so that the closer a position in the groove is to the boundary line of the forming region, the shallower and the narrower the groove at the position will be.

The embodiment describes the case where the end portion of the upper radial dynamic pressure groove 64 on the lower-edge 66 side is connected, at the central line 68, with the end portion of the corresponding lower radial dynamic pressure groove 74 on the upper-edge 62 side. However, the present invention is not limited to this. FIG. 8 is a development of a first radial dynamic pressure groove forming region 154 according to a modification. The radial dynamic pressure groove forming region 154 has: a first region 170, the structure of which being similar to that of the upper forming region 70; a second region 172, the structure of which being similar to that of the lower forming region 72; and a third region 171, being axially sandwiched between the first region 170 and the second region 172. No radial dynamic pressure groove is formed on the third region 171. In that, the end portion 164a of the upper radial dynamic pressure groove 164 on the lower-edge 166 side is separated, in the axial direction, from the end portion 174a of the corresponding lower radial dynamic pressure groove 174 on the upper-edge 162 side. According to this modification example, advantages similar to those realized by the rotating device 1 according to the embodiment can be realized.

What is claimed is:

1. A rotating device comprising a stator configured to rotatably support a rotor via a lubricant,
wherein a zonal region configured to surround a rotational axis of the rotor is formed on either one of a surface of the rotor and a surface of the stator, the surface of the rotor and the surface of the stator together forming a gap into which the lubricant is filled, and the zonal region creating dynamic pressure in the lubricant when the rotor rotates,
wherein a plurality of grooves along a direction that crosses the zonal region are formed on the zonal region from each of the both sides of the zonal region, and
wherein a groove formed from one side of the zonal region is formed so that the closer a position in the groove is to the other side of the zonal region, the shallower and the narrower the groove at the position will be, and
wherein a groove formed from the other side of the zonal region is formed so that the closer a position in the groove is to the one side of the zonal region, the shallower and the narrower the groove at the position will be.

2. The rotating device according to claim 1, wherein the plurality of grooves have a piezoelectric process surface, which has been cut by an edged tool, the edge of the edged tool being actuated in the radial direction using an piezoelectric element.

3. The rotating device according to claim 1, wherein the zonal region is formed so as to be substantially parallel to the rotational axis, and
wherein the plurality of grooves are regularly arranged in the circumferential direction.

4. The rotating device according to claim 1, wherein the angle formed by a direction along which the zonal region extends and the direction that crosses the zonal region is in the range of 10 degrees to 30 degrees, and
wherein the zonal region is a cylindrical region, the center of which being the rotational axis, the diameter of the cylindrical region being in the range of 1.5 mm to 4.5 mm, and
wherein the plurality of grooves are formed so that the plurality of grooves are symmetric with respect to a line that passes through the middle of the zonal region,
wherein the number of grooves formed from the one side of the zonal region is in the range of 8 to 12, and
wherein the groove formed from the one side of the zonal region is formed so that the depth of one end of the groove is in the range of 4 μm to 8 μm and that the depth of the other end of the groove is in the range of 2 μto 3.5 μm, the one end of the groove corresponding to the one side of the zonal region and the other end of the groove corresponding to the other side of the zonal region.

5. The rotating device according to claim 1, wherein the plurality of grooves are regularly arranged in the circumferential direction, and
wherein the groove formed from the one side of the zonal region is formed so that the ratio of the width of the groove to the pitch of the groove at one end of the groove is in the range of 0.50 to 0.80 and that the ratio of the width of the groove to the pitch of the groove at the other end of the groove is in the range of 0.10 to 0.30, the one end of the groove corresponding to the one side of the zonal region and the other end of the groove corresponding to the other side of the zonal region.

6. The rotating device according to claim 1, wherein the groove formed from the one side of the zonal region and the groove formed from the other side of the zonal region are separated from each other in the axial direction.

7. The rotating device according to claim 1, wherein the groove formed from the one side of the zonal region is formed so that the depth of the other end of the groove is less than two-thirds of the depth of one end of the groove and that the ratio of the width of the groove to the depth of the groove at the other end of the groove is 0.67 to 1.50 times the ratio of the width of the groove to the depth of the groove at the one end of the groove, the one end of the groove corresponding to the one side of the zonal region and the other end of the groove corresponding to the other side of the zonal region.

8. A rotating device comprising a stator configured to rotatably support a rotor via a lubricant,
wherein a zonal region configured to surround a rotational axis of the rotor is formed on either one of a surface of the rotor and a surface of the stator, the surface of the rotor and the surface of the stator together forming a gap into which the lubricant is filled, and the zonal region creating dynamic pressure in the lubricant when the rotor rotates, and
wherein a plurality of grooves along a direction that crosses the zonal region are formed on the zonal region from one side of the zonal region towards the other side of the zonal region, and
wherein a groove formed from one side of the zonal region is formed so that the closer a position in the groove is to the other side of the zonal region, the shallower and the narrower the groove at the position will be.

9. The rotating device according to claim 8, wherein the plurality of grooves have a piezoelectric process surface, which has been cut by an edged tool, the edge of the edged tool being actuated in the radial direction using an piezoelectric element.

10. The rotating device according to claim 8, wherein the zonal region is formed so as to be substantially parallel to the rotational axis, and
wherein the plurality of grooves are regularly arranged in the circumferential direction.

11. The rotating device according to claim 8, wherein the angle formed by a direction along which the zonal region extends and the direction that crosses the zonal region is in the range of 10 degrees to 30 degrees, and
wherein the zonal region is a cylindrical region, the center of which being the rotational axis, the diameter of the cylindrical region being in the range of 1.5 mm to 4.5 mm, and
wherein the number of grooves formed from the one side of the zonal region is in the range of 8 to 12, and
wherein the groove formed from the one side of the zonal region is formed so that the depth of one end of the groove is in the range of 4 μm to 8 μm and that the depth of the other end of the groove is in the range of 2 μm to 3.5 μm, the one end of the groove corresponding to the one side of the zonal region and the other end of the groove corresponding to the other side of the zonal region.

12. The rotating device according to claim 8, wherein the plurality of grooves are regularly arranged in the circumferential direction, and
wherein the groove formed from the one side of the zonal region is formed so that the ratio of the width of the groove to the pitch of the groove at one end of the groove is in the range of 0.50 to 0.80 and that the ratio of the width of the groove to the pitch of the groove at the other end of the groove is in the range of 0.10 to 0.30, the one end of the groove corresponding to the one side of the zonal region and the other end of the groove corresponding to the other side of the zonal region.

13. The rotating device according to claim 8, wherein the groove formed from the one side of the zonal region is formed so that the depth of the other end of the groove is less than two-thirds of the depth of one end of the groove and that the ratio of the width of the groove to the depth of the groove at the other end of the groove is 0.67 to 1.50 times the ratio of the width of the groove to the depth of the groove at the one end of the groove, the one end of the groove corresponding to the one side of the zonal region and the other end of the groove corresponding to the other side of the zonal region.

14. A rotating device comprising a stator configured to rotatably support a rotor via a lubricant,
wherein a zonal region configured to surround a rotational axis of the rotor is formed on either one of a surface of the rotor and a surface of the stator, the surface of the rotor and the surface of the stator together forming a gap into which the lubricant is filled, and the zonal region creating dynamic pressure in the lubricant when the rotor rotates, and
wherein a plurality of grooves along a direction that crosses the zonal region are formed on the zonal region from each of both sides of the zonal region, and
wherein a groove formed from one side of the zonal region is formed so that the closer a position in the groove is to the other side of the zonal region, the less the cross sectional area of the groove at the position will be, the cross section being taken in a direction along which the zonal region extends, and
wherein a groove formed from the other side of the zonal region is formed so that the closer a position in the groove is to the one side of the zonal region, the less the cross sectional area of the groove at the position will be, the cross section being taken in a direction along which the zonal region extends.

15. The rotating device according to claim 14, further comprising a bearing unit arranged between the rotor and the stator,
wherein the bearing unit includes a cup-like housing, the outer surface of the housing being fixed into a bearing hole arranged in a base and the bearing hole being arranged radially inwardly of a clamper fixing portion of the rotor, and
wherein an interface of the lubricant is positioned in the middle of a side surface of the housing.

16. The rotating device according to claim 14, further comprising a bearing unit arranged between the rotor and the stator,
wherein the bearing unit includes:
a hanging portion configured to rotate integrally with a hub of the rotor, the hanging portion having a first end surface and a second end surface, which is opposite to the first end surface; and
an extending portion that is non-rotatably arranged so that the extending portion extends radially outward into an axial gap between the hanging portion and the hub,
wherein, radially inwardly of a clamper fixing portion of the rotor, a thrust dynamic pressure groove is formed on either one of the first end surface of the hanging portion and a surface of the extending portion facing the first end surface.

17. The rotating device according to claim 16, wherein the bearing unit further includes a facing portion that is fixedly arranged onto a base, the facing portion having a facing surface that axially faces the second end surface of the hanging portion,
wherein, radially inward of the clamper fixing portion, another thrust dynamic pressure groove is formed on either one of the second end surface of the hanging portion and the facing surface.

18. The rotating device according to claim 14, wherein the angle formed by a direction along which the zonal region extends and the direction that crosses the zonal region is in the range of 10 degrees to 30 degrees, and
wherein the zonal region is a cylindrical region, the center of which being the rotational axis, the diameter of the cylindrical region being in the range of 1.5 mm to 4.5 mm, and
wherein the plurality of grooves are formed so that the plurality of grooves are symmetric with respect to a line that passes through the middle of the zonal region,
wherein the number of grooves formed from the one side of the zonal region is in the range of 8 to 12,
wherein the groove formed from the one side of the zonal region is formed so that the depth of one end of the groove is in the range of 4 μm to 8 μm and that the depth of the other end of the groove is in the range of 2 μm to 3.5 μm, the one end of the groove corresponding to the one side of the zonal region and the other end of the groove corresponding to the other side of the zonal region.

19. The rotating device according to claim 14, wherein the plurality of grooves are regularly arranged in the circumferential direction, and
wherein the groove formed from the one side of the zonal region is formed so that the ratio of the width of the groove to the pitch of the groove at one end of the groove is in the range of 0.50 to 0.80 and that the ratio of the width of the groove to the pitch of the groove at the other end of the groove is in the range of 0.10 to 0.30, the one end of the groove corresponding to the one side of the zonal region and the other end of the groove corresponding to the other side of the zonal region.

20. The rotating device according to claim 14, wherein the groove formed from the one side of the zonal region is formed so that the depth of the other end of the groove is less than two-thirds of the depth of one end of the groove and that the ratio of the width of the groove to the depth of the groove at the other end of the groove is 0.67 to 1.50 times the ratio of the width of the groove to the depth of the groove at the one end of the groove, the one end of the groove corresponding to the one side of the zonal region and the other end of the groove corresponding to the other side of the zonal region.
